(19) United States
(12) Patent Application Publication
(10) Pub. No.: US 2026/0145670 A1
(43) Pub. Date: May 28, 2026

(54) ELECTRONIC DEVICE, METHOD, AND NON-TRANSITORY COMPUTER READABLE STORAGE MEDIUM FOR PREVENTING COLLISION USING CAMERA

(71) Applicant: THINKWARE CORPORATION, Seongnam-si (KR)

(72) Inventors: Sukpil KO, Seongnam-si (KR); Haejong CHOI, Seongnam-si (KR)

(21) Appl. No.: 19/403,083

(22) Filed: Nov. 27, 2025

(30) Foreign Application Priority Data
Nov. 27, 2024 (KR) 10-2024-0172893

(51) Int. Cl. B60W 30/09; B60Q 9/00; B60R 1/23; B60W 60/00; G06V 10/764; G06V 20/40; G06V 20/58; H04N 7/18

(52) U.S. Cl. CPC B60W 30/09; B60Q 9/008; B60R 1/23; B60W 60/0015; G06V 10/764; G06V 20/40; G06V 20/58; B60R 2300/307; B60R 2300/8093; B60W 2300/14; B60W 2420/403; B60W 2420/54; B60W 2530/201; B60W 2540/18; B60W 2556/45; H04N 7/183

(57) ABSTRACT

An electronic device in a vehicle includes memory storing instructions, a communication interface, and at least one processor. The instructions cause the electronic device to receive, via the communication interface, from a camera included in the vehicle, a video with respect to a peripheral environment of the vehicle, using the video, obtain position information with respect to an external object included in the peripheral environment, receive, via the communication interface, from a wheel sensor included in the vehicle, rotation information indicating an angle of a steering wheel in the vehicle, using the rotation information and the position information, determine whether the external object is included in a risk region expected to be occupied by the vehicle moving in accordance with the angle, and based on determining that the external object is included in the risk region, generate notification information with respect to the external object.

### TECHNICAL FIELD

The present disclosure relates to an electronic device, a method, and a non-transitory computer readable storage medium for preventing a collision using a camera.

### BACKGROUND ART

An electronic device may include a communication interface. The electronic device may be connected to a camera via a communication interface. For example, the electronic device may receive an image from the camera via the communication interface. The electronic device may identify an object included in the image by using the received image. The electronic device may identify a type of the object included in the image by using the received image.

The above-described information may be provided as a related art for the purpose of helping understanding of the present disclosure.

No argument or decision is made as to whether any of the above description may be applied as a prior art related to the present disclosure.

### SUMMARY

### Technical Solution

An electronic device in a vehicle is described. The electronic device may comprise memory, storing instructions, comprising one or more storage mediums. The electronic device may comprise a communication interface. The electronic device may comprise at least one processor comprising processing circuitry. The instructions, when executed by the at least one processor individually or collectively, may cause the electronic device to receive, via the communication interface, from a camera included in the vehicle, a video with respect to a peripheral environment of the vehicle. The instructions, when executed by the at least one processor individually or collectively, may cause the electronic device to, using the video, obtain position information with respect to an external object included in the peripheral environment. The instructions, when executed by the at least one processor individually or collectively, may cause the electronic device to receive, via the communication interface, from a wheel sensor included in the vehicle, rotation information indicating an angle of a steering wheel in the vehicle. The instructions, when executed by the at least one processor individually or collectively, may cause the electronic device to, using the rotation information and the position information, determine whether the external object is included in a risk region expected to be occupied by the vehicle moving in accordance with the angle. The instructions, when executed by the at least one processor individually or collectively, may cause the electronic device to, based on determining that the external object is included in the risk region, generate notification information with respect to the external object.

A method is provided. The method may be executed in an electronic device, having a communication interface, in a vehicle. The method may comprise receiving, via the communication interface, from a camera included in the vehicle, a video with respect to a peripheral environment of the vehicle. The method may comprise, by using the video, obtaining position information with respect to an external object included in the peripheral environment. The method may comprise receiving, via the communication interface, from a wheel sensor included in the vehicle, rotation information indicating an angle of a steering wheel in the vehicle. The method may comprise, by using the rotation information and the position information, determining whether the external object is included in a risk region expected to be occupied by the vehicle moving in accordance with the angle. The method may comprise, based on determining that the external object is included in the risk region, generating notification information with respect to the external object.

A non-transitory computer readable storage medium is provided. The non-transitory computer readable storage medium may store one or more programs. The one or more programs may comprise instructions to, when executed by an electronic device, having a communication interface, in a vehicle, cause the electronic device to receive, via the communication interface, from a camera included in the vehicle, a video with respect to a peripheral environment of the vehicle. The one or more programs may comprise instructions to, when executed by the electronic device, cause the electronic device to, using the video, obtain position information with respect to an external object included in the peripheral environment. The one or more programs may comprise instructions to, when executed by the electronic device, cause the electronic device to receive, via the communication interface, from a wheel sensor included in the vehicle, rotation information indicating an angle of a steering wheel in the vehicle. The one or more programs may comprise instructions to, when executed by the electronic device, cause the electronic device to, using the rotation information and the position information, determine whether the external object is included in a risk region expected to be occupied by the vehicle moving in accordance with the angle. The one or more programs may comprise instructions to, when executed by the electronic device, cause the electronic device to, based on determining that the external object is included in the risk region, generate notification information with respect to the external object.

### BRIEF DESCRIPTION OF THE DRAWINGS

FIGS. 1A and 1B illustrate an example of a conventional truck.

FIG. 2 is a simplified block diagram of an electronic device in a vehicle and a module included in the vehicle.

FIG. 3 is a flowchart illustrating an operation of an electronic device generating notification information.

FIGS. 4A and 4B illustrate an exemplary operation of an electronic device classifying an object in a video.

FIG. 5 illustrates an example of a risk region based on a rotation angle.

FIG. 6 illustrates an exemplary operation of an electronic device providing a notification in accordance with a risk region.

FIG. 7 illustrates an example of a block diagram illustrating an autonomous driving system of a vehicle according to an embodiment.

FIGS. 8 and 9 illustrate an example of a block diagram illustrating an autonomous moving object according to an embodiment.

FIG. 10 illustrates an example of a gateway associated with a user device according to various embodiments.

FIG. 11 is a diagram for describing an operation of an electronic device training a neural network based on a set of training data according to an embodiment.

FIG. 12 is a block diagram of an electronic device according to an embodiment.

### DETAILED DESCRIPTION OF EXEMPLARY EMBODIMENTS

Specific structural or functional descriptions of embodiments according to the concept of the present invention disclosed in the present specification are merely illustrated for the purpose of describing the embodiments according to the concept of the present invention, and the embodiments according to the concept of the present invention may be implemented in various forms and are not limited to the embodiments described in the present specification.

Since the embodiments according to the concept of the present invention may be modified in various ways and may have various forms, the embodiments will be illustrated in the drawings and described in detail in the present specification. However, this is not intended to limit the embodiments according to the concept of the present invention to specific disclosed forms, but includes modifications, equivalents, or substitutes that are included in the spirit and the scope of the present invention.

Terms such as ‘first’ and ‘second’ may be used to describe various elements, but the elements should not be limited by the terms. The terms are used only for the purpose of distinguishing one element from another, and for example, without departing from the scope of the concept of the present invention, a first element may be referred to as a second element, and similarly, the second element may also be referred to as the first element.

When an element is referred to as being “connected” or “coupled” to another element, it should be understood that the element may be directly connected or coupled to the other element, or intervening elements may be present between them. On the other hand, when an element is referred to as being “directly connected” or “directly coupled” to another element, it should be understood that there are no intervening elements present between them. Expressions describing a relationship between elements, such as “between,” “directly between,” or “directly adjacent to,” should be interpreted in the same manner.

The terminology used in the present specification is intended only to describe specific embodiments and is not intended to limit the present invention. Singular expressions include plural expressions unless the context clearly indicates otherwise. In the present specification, terms such as “include” or “have” are intended to specify that features, numbers, steps, operations, components, parts, or combinations thereof are present, but should be understood not to preclude the possibility that one or more other features, numbers, steps, operations, components, parts, or combinations thereof may also be present or added.

Unless otherwise defined, all terms used herein, including technical and scientific terms, have the same meanings as commonly understood by one of ordinary skill in the art to which the present invention pertains. Terms that are defined in generally used dictionaries are to be interpreted as having meanings consistent with the contextual meaning in the relevant art and are not to be interpreted in an idealized or overly formal sense unless explicitly defined in the present specification.

Hereinafter, embodiments will be described in detail with reference to the accompanying drawings. However, the scope of the present patent application is not limited or restricted by these embodiments. The same reference numerals shown in the respective drawings may denote the same components, and redundant descriptions thereof may be omitted.

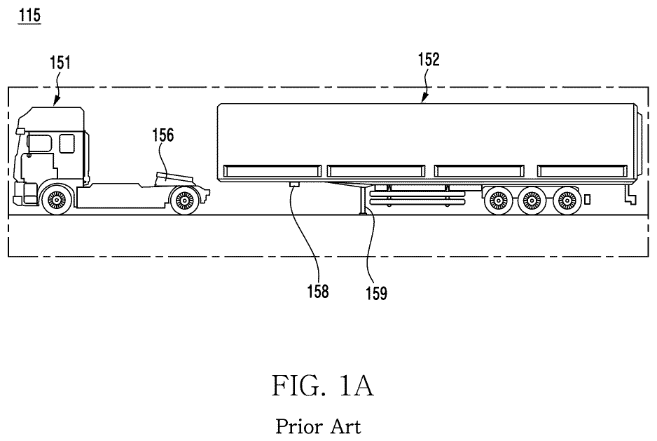

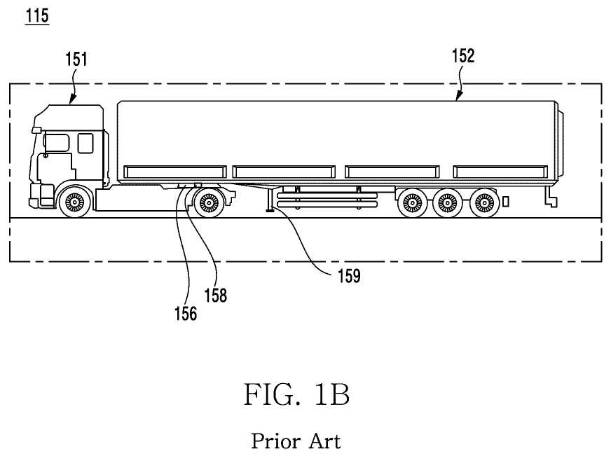

FIGS. 1A and 1B illustrate an example of a conventional truck. Over the years, a trucking industry has experienced steady growth and has expanded a range of its services to respond to increasingly complex supply chains. Such services include last-mile deliveries, drop-trailer programs, and intermodal transportation at ports (a form of transportation in which freight is carried to its destination by two or more different modes of transportation (ship and train, or ship and airplane)).

As such, since there are various methods of transporting freight, manufacturers of freight transportation equipment have designed different types of equipment for transporting freight according to various transportation needs.

In the present specification, a truck that tows a trailer for the main purpose of carrying (or catering) freight will be collectively referred to as a tractor.

The tractor described in the present specification may be classified, according to a position and a shape of a cab of the tractor, into a conventional truck (or a bonneted truck) , a cab-over truck (or a cab-over engine), and a semi-conventional truck, which is an intermediate type between the conventional truck and the cab-over truck.

The conventional truck is a type in which an engine and a hood are positioned over a front axle in front of the cab of the tractor, and has a structure in which a driver sits behind a front axle, and is a type of the tractor mainly used in North America, where the engine of the tractor is positioned in a front side of the driver.

On the other hand, the cab-over truck is a type has a structure in which the driver sits in a front of the front axle as the cab of the tractor is positioned up to the very front end of the tractor, and is a so-called “flat face (or flat nose)” type in which the front side of the tractor is flat, and is a type of the tractor mainly used in most countries such as Europe and Asia, where the engine of the tractor is positioned under the driver.

As various types exist according to a purpose and a demand of a tractor, various types of trailers towed by the tractor also exist. Among them, the most representative types of trailers are a full trailer and a semi-trailer. The full trailer and the semi-trailer may be distinguished according to whether both a front axle and a rear axle are mounted on the trailer. These trailers may be connected to a box truck or a tractor through a coupling device.

Specifically, the full trailer is a commercial freight trailer on which both the front axle and the rear axle are mounted. The full trailer is designed so that a total load is supported only by the trailer itself, and may fully support its own weight without relying on the tractor, and is equipped with a drawbar to be coupled to a hauling unit or a towing unit such as a tractor, and is mainly used in countries such as the United States and the Canada.

On the other hand, the semi-trailer is a freight trailer on which only the rear axle is mounted without the front axle, and a large portion of a load may be supported by a tractor connected through a kind of hitch called a “fifth wheel (steering wheel),” which is a type of turning wheel. When the semi-trailer is in a stationary state by being detached from the tractor, the load of the trailer may be supported by vertically deploying a landing gear mounted on a lower portion of the semi-trailer to the ground. A combination of the semi-trailer and the tractor is called a semi-trailer truck (in the United States, it is simply referred to as a “semi-trailer,” a “tractor-trailer,” a “semi-truck,” a “big rig,” or a “semi”). The above-described “fifth wheel” refers to a horizontal wheel attached to the tractor axle of a trailer truck to facilitate direction change of the trailer, and is also called a “fifth wheel”. The “fifth wheel” is a device that allows the tractor and the semi-trailer to be movably coupled, and generally includes a lower portion consisting of a trunnion plate and a latch device that firmly fixes a kingpin mounted on the semi-trailer to the tractor.

Hereinafter, in the present specification, based on the above-described terms of the tractor and the trailer, for convenience of description, the term “trailer” will be used to refer to a freight transport vehicle connected to a tractor for a trailer, and the term “tractor” will be used to refer to a towing vehicle for moving the trailer. In addition, in the present invention, in order to minimize limitation of rights according to embodiments described in the detailed description, the tractor may also be referred to as a “towing vehicle” that tows the trailer, and the trailer may also be referred to as a “towed vehicle” that is towed by the tractor.

For convenience of description, it is preferable to understand that the “trailer” described throughout the present specification refers to the “semi-trailer,” but is not limited thereto.

Referring to FIGS. 1A and 1B, a vehicle 115 may include a tractor or a tractor unit 151 and a semi-trailer 152. FIG. 1A indicates a state in which the tractor 151 and the semi-trailer 152 are not connected, and FIG. 1B indicates a state in which the tractor 151 and the semi-trailer 152 are connected.

In an embodiment, the semi-trailer 152 may be selectively connected by a fifth wheel hitch 156 carried by the tractor 151, and the fifth wheel hitch 156 may be fastened according to a method known to a kingpin 158 fixed to the semi-trailer 152. The vehicle 115 including the tractor 151 and the semi-trailer 152 may be referred to as a truck. The vehicle 115 may include only the tractor 151. The semi-trailer 152 illustrated in FIGS. 1A and 1B has been illustrated in a form of the “semi-trailer”, but this is for convenience of explanation, and an embodiment of the present disclosure should not be understood to be applied only to the form of the “semi-trailer”. The tractor 151 illustrated in FIGS. 1A and 1B has been illustrated in a form of the “cab-over truck”, but this is for convenience of explanation, and the embodiment of the present disclosure should not be understood as being applied only to the form of the “cab-over truck”.

In an embodiment, the semi-trailer 152 may include the kingpin 158 coupled to the fifth wheel hitch 156 of the tractor 151 and a landing gear 159 supporting the semi-trailer 152 from the ground in a state in which the semi-trailer 152 is not coupled to the tractor 151. The kingpin 158 and the landing gear 159 may be installed (or disposed) in a lower portion of the semi-trailer 152.

In an embodiment, the semi-trailer 152 may be rotatably coupled to the tractor 151 to support driving on a curved road. For example, the tractor 151 and the semi-trailer 152 may be rotatably coupled through a coupling device including the fifth wheel hitch 156 and the kingpin 158. However, a link mechanism between the tractor 151 and the semi-trailer 152 is not limited thereto.

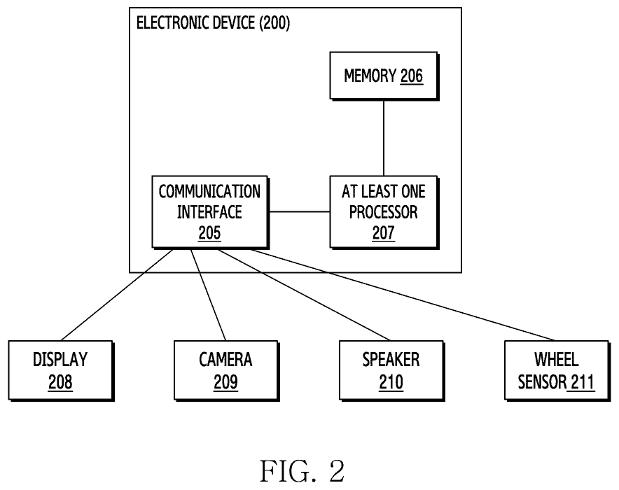

FIG. 2 is a simplified block diagram of an electronic device in a vehicle and a module included in the vehicle.

Referring to FIG. 2, an electronic device 200 may include at least one processor 207, a communication interface 205, and memory 206. A vehicle 115 may include the electronic device 200, a display 208, a camera 209, a speaker 210, and a wheel sensor 211. The electronic device 200 included in the vehicle 115 may be referred to as an Electronic Control Unit (ECU). For example, the ECU may include a device that controls a module or a component included in the vehicle 115. For example, the electronic device 200 may control one or more among the display 208, the camera 209, the speaker 210, and the wheel sensor 211.

The at least one processor 207 may include a hardware component for processing data by using instructions stored in the memory 206. The hardware component for processing data may include a central processing unit (CPU) (e.g., including processing circuitry). The hardware component for processing data may include a graphic processing unit (GPU) (e.g., including processing circuitry). The hardware component for processing data may include a display processing unit (DPU) (e.g., including processing circuitry). The hardware component for processing data may include a natural processing unit (NPU) (e.g., including processing circuitry).

The at least one processor 207 may include one or more cores. For example, the at least one processor 207 may have a structure of a multi-core processor such as a dual core, a quad core, or a hexa core.

The memory 206 may include a hardware component for storing data and/or instructions inputted to and/or outputted from the at least one processor 207. The memory 206 may include, for example, a volatile memory such as a random-access memory (RAM) and/or a non-volatile memory such as a read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multimedia card (EMMC).

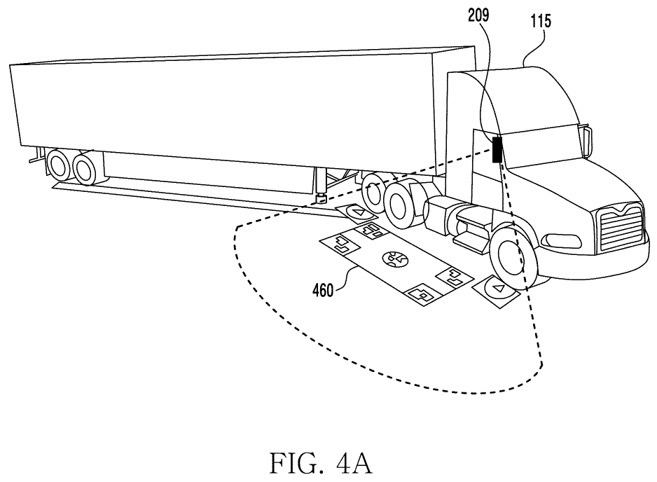

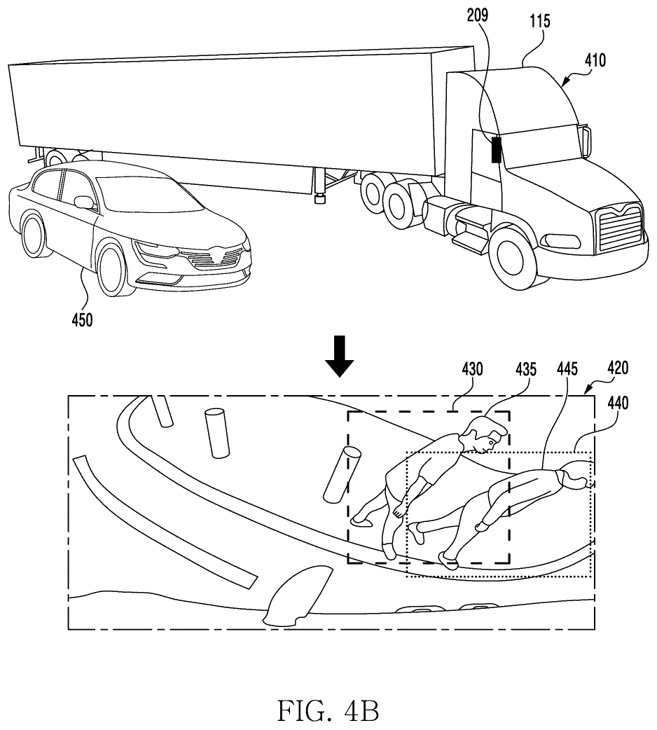

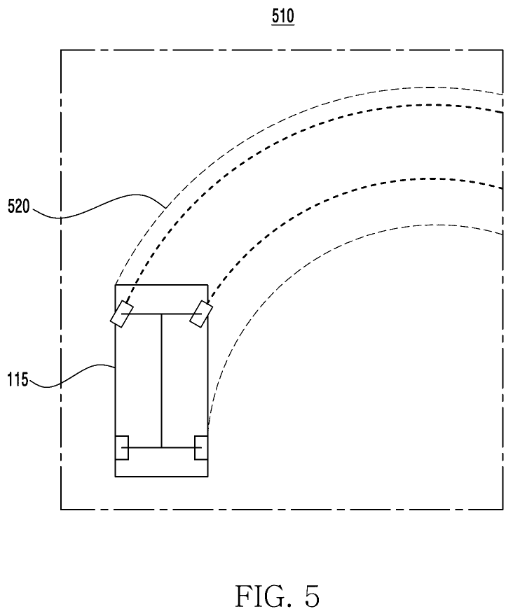

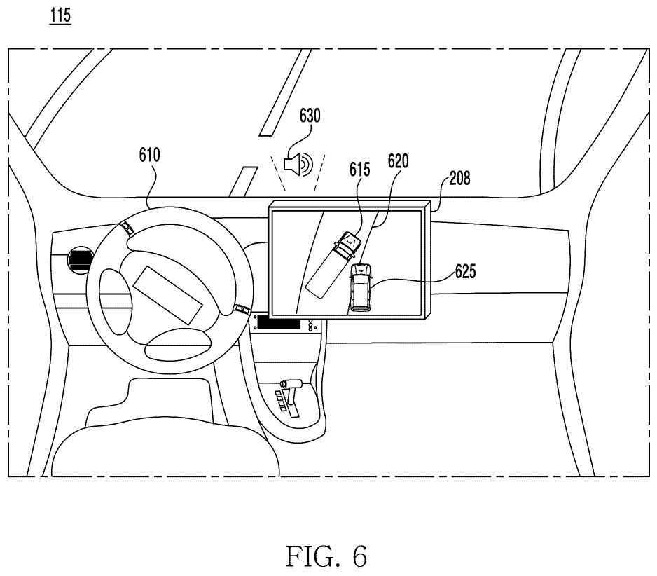

The vehicle 115 may include a plurality of modules. For example, the module may include the display 208, the camera 209, the speaker 210, and the wheel sensor 211. The display 208 may be used to display an image received from the electronic device 200 through the communication interface 205. The camera 209 may obtain an image or a video of an environment in which the vehicle 115 is included. The electronic device 200 may receive the image or the video obtained from the camera 209 through the communication interface 205. The at least one processor 207 may obtain position information with respect to an external object included in a peripheral environment of the vehicle 115 by using the video. The at least one processor 207 may receive rotation information indicating an angle of a steering wheel (e.g., a steering wheel 610 of FIG. 6) of the vehicle 115 from the wheel sensor 211 included in the vehicle 115 through the communication interface 205. For example, the wheel sensor 211 may obtain rotation information indicating a rotation angle of the steering wheel. The at least one processor 207 may determine, using the rotation information and the position information, whether the external object (e.g., an external object 450 of FIG. 4B) is included in a risk region (e.g., a risk region 520 of FIG. 5) expected to be occupied by the vehicle 115 moving in accordance with the angle. For example, the at least one processor 207 may generate notification information with respect to the external object, based on determining that the external object (e.g., the external object 450 of FIG. 4B) is included in the risk region (e.g., the risk region 520 of FIG. 5). For example, the speaker 210 may receive the notification information from the electronic device 200. For example, the speaker 210 may output an audio (e.g., an audio 630 of FIG. 6) warning of a collision using the received notification information.

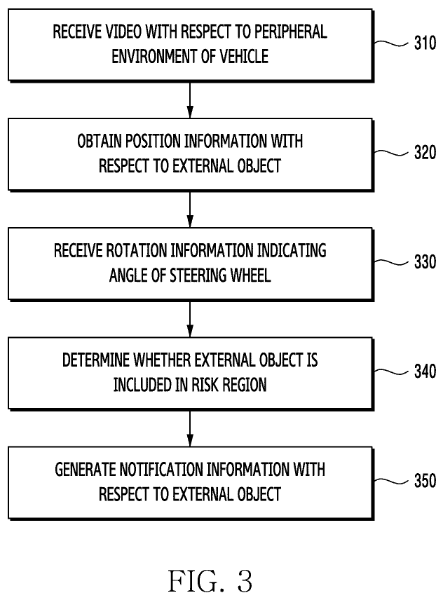

FIG. 3 is a flowchart illustrating an operation of an electronic device generating notification information.

Referring to FIG. 3, in operation 310, an electronic device 200 may receive a video with respect to a peripheral environment of a vehicle 115 from a camera 209 included in the vehicle 115 through a communication interface 205. For example, the camera 209 may be included in the vehicle 115 and arranged toward the peripheral environment of the vehicle 115. For example, the peripheral environment may be described as a real environment. For example, the peripheral environment may include the vehicle 115. For example, the peripheral environment may include an external object (e.g., the external object 450 of FIG. 4B). For example, the camera 209 may obtain an image with respect to the peripheral environment. For example, the camera 209 may obtain a video with respect to the peripheral environment. For example, the camera 209 may transmit the obtained video to the electronic device 200.

In operation 320, the electronic device 200 may obtain position information with respect to the external object (e.g., the external object 450 of FIG. 4B) included in the peripheral environment by using the received video from the camera 209. For example, the electronic device 200 may analyze the video using a pre-trained model (not illustrated). Obtaining of the position information with respect to the external object will be described and exemplified in more detail with reference to FIGS. 4A and 4B.

FIGS. 4A and 4B illustrate an exemplary operation of an electronic device classifying an object in a video.

Referring to FIG. 4A, a camera 209 may be included or installed in a vehicle 115. For example, the camera 209 may be required to perform calibration after being installed in the vehicle 115. For example, the camera 209 may perform the calibration using a predefined pattern 460. For example, the predefined pattern 460 may be installed in a lateral side of the vehicle 115. For example, the camera 209 may obtain an image with respect to the predefined pattern 460. For example, the camera 209 may transmit the image with respect to the predefined pattern 460 to an electronic device 200. For example, the electronic device 200 may receive the image with respect to the predefined pattern 460 from the camera 209 through a communication interface 205. For example, the electronic device 200 may estimate a position of the camera 209 using the predefined pattern 460. For example, the electronic device 200 may estimate the position of the camera 209 using an internal parameter measured through projective geometry. For example, the electronic device 200 may estimate the position of the camera 209 using an external parameter as a variable. For example, the electronic device 200 may estimate or calculate the position of the camera 209 based on a visual object with respect to the predefined pattern 460 included in the image. For example, the electronic device 200 may determine a positional relationship between an external object 450 and the vehicle 115 by using the calculated position of the camera 209.

Referring to FIG. 4B, the vehicle 115 may include the camera 209. For example, a state 410 may be described as a state of obtaining a video using the camera 209 included in the vehicle 115. For example, the camera 209 may obtain a video with respect to a peripheral environment. For example, the camera 209 may obtain a video in which the external object 450 is included. For example, the external object 450 may include a person. For example, the external object 450 may include a road. For example, the external object 450 may include another vehicle. For example, the external object 450 may include a streetlamp. For example, the camera 209 may transmit the obtained video to the electronic device 200. For example, the electronic device 200 may receive the video from the camera 209 through the communication interface 205.

A state 420 may be described as a state of classifying a visual object included in the video by using the video. For example, the electronic device 200 may analyze the video using a pre-trained model (not illustrated). For example, the pre-trained model may be described as a model trained through a machine learning technique. For example, machine learning may include deep learning. For example, the pre-trained model may include a model trained to classify a type of a visual object in the video. For example, the vehicle 115 may include the pre-trained model. For example, the electronic device 200 may include the pre-trained model. However, it is not limited thereto. For example, the vehicle 115 may include an external electronic device including the pre-trained model. For example, the electronic device 200 may obtain information with respect to a visual object in the video by analyzing the video. For example, the pre-trained model may identify a visual object in the video, by using the video. For example, the pre-trained model may identify a visual object in the video using a bounding box. For example, the pre-trained model may identify a visual object included in the bounding box based on a bounding box 430 and a bounding box 440. For example, the pre-trained model may identify a visual object 435 included in the bounding box 430. For example, the pre-trained model may identify a visual object 445 included in the bounding box 440. For example, the electronic device 200 may identify whether a visual object is included in the video using the pre-trained model. For example, the electronic device 200 may identify whether an external object is positioned in an external environment represented in the video using the pre-trained model.

The electronic device 200 may identify a type of an external object corresponding to a visual object using the pre-trained model. For example, the electronic device 200 may identify a type of the identified visual object using a bounding box. For example, the electronic device 200 may determine whether the external object is what type of object by using the pre-trained model. For example, the electronic device 200 may identify the type of the external object corresponding to the visual object using the pre-trained model.

For example, the electronic device 200 may identify the type of the external object using an image segmentation technique. For example, the image segmentation technique may be described as a technique to identify a type of an object by separating pixels of a visual object included in an image or a video. For example, the electronic device 200 may perform the image segmentation technique using the pre-trained model. For example, the electronic device 200 may identify or determine the type of the external object corresponding to the visual object included in the video by performing the image segmentation technique on the video. From a model trained to perform the image segmentation technique, the electronic device 200 may obtain, or identify, an external object (e.g., a road, a lane, and/or a person) corresponding to each of the pixels of the image and/or the video. For example, the at least one processor 207 may identify that the visual object 435 included in the bounding box 430 indicates a person by performing the image segmentation technique. For example, at least one processor 207 may identify that the visual object 445 included in the bounding box 440 indicates a person by performing the image segmentation technique. For example, the electronic device 200 may determine whether the external object 450 is allowed to be included in a risk region (e.g., the risk region 520 of FIG. 5). For example, when the external object 450 is a person, it does not allow for the external object 450 to be included in the risk region. For example, when the external object 450 is a road, it does not allow for the external object 450 to be included in the risk region.

The electronic device 200 may obtain position information of a visual object included in the video by performing a back-projection with respect to the video obtained through the camera 209. For example, the electronic device 200 may obtain information with respect to a coordinate in which the position of the camera 209 is set as an origin by performing the back-projection. For example, the electronic device 200 may determine or obtain a coordinate of the visual object in the video on the coordinate in which the position of the camera 209 is set as the origin by performing the back-projection. For example, the electronic device 200 may obtain 3D coordinate information with respect to the visual object in the video by performing the back-projection.

According to an embodiment, the vehicle 115 may include an ultrasonic sensor (not illustrated). For example, the ultrasonic sensor may detect whether the external object 450 is positioned using an ultrasonic wave. For example, the ultrasonic sensor may detect whether the external object 450 exists in the peripheral environment including the vehicle 115 using the ultrasonic wave. For example, the ultrasonic sensor may obtain object data by detecting whether the external object 450 exists using the ultrasonic wave. For example, the ultrasonic sensor may transmit the object data to the electronic device 200. For example, the electronic device 200 may receive the object data from the ultrasonic sensor through the communication interface 205. For example, the electronic device 200 may identify whether the external object 450 exists in the peripheral environment of the vehicle 115 using the object data. For example, the electronic device 200 may detect another external object positioned in the risk region (e.g., the risk region 520 of FIG. 5) using the ultrasonic sensor arranged toward a blind spot based on identifying the risk region including the blind spot of the camera 209. For example, the other external object may be different from the external object 450. However, it is not limited thereto. For example, the other external object may be the same as the external object 450. For example, the electronic device 200 may use the ultrasonic sensor to compensate for the blind spot of the vehicle 115. For example, the blind spot may include a spot not capable of being seen through a mirror included in the vehicle 115. For example, the blind spot may include a spot not capable of obtaining an image through the camera 209 included in the vehicle 115. For example, the electronic device 200 may use the ultrasonic sensor to detect whether the other external object is positioned in the blind spot. For example, the electronic device 200 may be required to detect the other external object using the ultrasonic sensor in a dark region (e.g., a tunnel). For example, the electronic device 200 may be required to detect the other external object using the ultrasonic sensor at night.

Referring back to FIG. 3, in operation 330, the electronic device 200 may receive rotation information indicating an angle of a steering wheel (e.g., the steering wheel 610 of FIG. 6) of the vehicle 115 from a wheel sensor 211 included in the vehicle 115 through the communication interface 205. For example, the wheel sensor 211 may obtain a rotation angle for the steering wheel (e.g., the steering wheel 610 of FIG. 6) of the vehicle 115. For example, the wheel sensor 211 may obtain information with respect to the rotation angle of the steering wheel of the vehicle 115. For example, the wheel sensor 211 may transmit the information with respect to the rotation angle of the steering wheel (e.g., the steering wheel 610 of FIG. 6) of the vehicle 115 to the electronic device 200.

In the operation 340, the electronic device 200 may determine whether the external object 450 is included in the risk region (e.g., the risk region 520 of FIG. 5) expected to be occupied by the vehicle 115 moving in accordance with the angle, using the rotation information and the position information with respect to the external object 450 included in the peripheral environment. The risk region will be described and exemplified in more detail with reference to FIG. 5.

FIG. 5 illustrates an example of a risk region based on a rotation angle.

Referring to FIG. 5, an electronic device 200 may receive rotation information indicating an angle of a steering wheel (e.g., the steering wheel 610 of FIG. 6) from a wheel sensor 211 through a communication interface 205. For example, a state 510 may be described as a state of displaying a risk region 520 determined in accordance with the angle of the steering wheel. For example, the electronic device 200 may determine the risk region 520 by using the rotation information. For example, the risk region 520 may include a region occupied by a vehicle 115 while the vehicle 115 rotates. For example, the risk region 520 may include a region in which the vehicle 115 sweeps while the vehicle 115 rotates. For example, while rotating, the vehicle 115 may indicate a rotation trajectory. For example, while rotating, the vehicle 115 may move in accordance with a rotation radius. For example, while rotating, the vehicle 115 may occupy a road on which the vehicle 115 travels, based on a wheel of a tractor and a wheel of a trailer. For example, while rotating, the vehicle 115 may occupy the road on which the vehicle 115 travels, based on the wheel of the tractor and the wheel of the trailer connected to the tractor.

For example, the risk region 520 may be determined in accordance with a rotation angle of the steering wheel (e.g., the steering wheel 610 of FIG. 6). For example, the electronic device 200 may determine the risk region 520 by using the rotation information received from the wheel sensor 211. For example, as the rotation angle increases, the risk region 520 may become wider. For example, the risk region 520 may be determined in accordance with a length of the trailer connected to the tractor. For example, the risk region 520 may become wider as a length of the vehicle 115 increases. For example, the risk region 520 may become wider as the length of the trailer connected to the tractor increases. For example, the vehicle 115 including the electronic device 200 may include a tractor capable of towing the trailer. For example, the electronic device 200 may determine whether an external object 450 is included in the risk region 520 using trailer information indicating the length of the trailer connected to the tractor. For example, the electronic device 200 may calculate or determine the risk region 520 using the trailer information. For example, the electronic device 200 may determine whether the external object 450 is included in the risk region 520 using a video obtained through a camera 209. For example, the electronic device 200 may determine a positional relationship between a visual object, corresponding to the external object 450, included in the video, and the risk region 450, using the video. For example, the electronic device 200 may generate notification information with respect to the external object 450 based on a distance between the visual object corresponding to the external object 450 and the risk region 520 is less than a threshold distance. For example, the electronic device 200 may obtain the distance between the external object 450 and the risk region 520 by performing a back-projection.

According to an embodiment, the electronic device 200 may set a peripheral region of a region in which the vehicle 115 sweeps while traveling as the risk region 520. For example, the electronic device 200 may determine a region to be occupied by the vehicle 115 using the rotation angle of the steering wheel (e.g., the steering wheel 610 of FIG. 6) while the vehicle 115 is rotating. For example, in order to prevent an unexpected collision event, the electronic device 200 may determine the region to be occupied by the vehicle 115 and a region adjacent to the region as the risk region 520. For example, the electronic device 200 may determine the region to be occupied by the vehicle 115 and a region within a predetermined length (e.g., 50 cm) from the region, as the risk region 520. For example, the electronic device 200 may set or determine the region within the predetermined length from the region to be occupied by the vehicle 115 as the risk region 520. For example, the electronic device 200 may prevent a collision with the external object 450 or reduce a frequency of the collision, by setting a region larger than the region to be occupied by the vehicle 115 as the risk region 520.

For example, when the external object 450 is included in the risk region 520 while the vehicle 115 rotates, the vehicle 115 and the external object 450 may collide. For example, when the external object 450, for which avoiding a collision with the vehicle 115 is required, is included in the risk region 520 while the vehicle 115 rotates, the vehicle 115 may be required to avoid a collision. For example, the electronic device 200 may identify a type of the visual object corresponding to the external object 450 included in a peripheral environment using the video obtained through the camera 209 based on a pre-trained model. For example, the electronic device 200 may determine whether the external object 450 is allowed to be included in the risk region 520 using the identified type. For example, when identifying that the external object 450 is a person, the electronic device 200 may determine that the external object 450 is not allowed to be included in the risk region 520. For example, when identifying that the external object 450 is a road, the electronic device 200 may determine that the external object 450 is allowed to be included in the risk region 520.

Referring back to FIG. 3, in operation 350, the electronic device 200 may generate notification information with respect to the external object 450 based on determining that the external object 450 is included in the risk region 520. For example, the electronic device 200 may determine whether the external object 450 is included in the risk region 520 using the video obtained through the camera 209. For example, the electronic device 200 may generate notification information with respect to the external object 450. For example, the notification information may include information with respect to a position of the external object 450. For example, the notification information may include a positional relationship between the external object 450 and the risk region 520. The electronic device 200 may provide a notification to a user (e.g., a driver) of the vehicle 115 by using the notification information. The provision of the notification will be described and exemplified in more detail with reference to FIG. 6.

FIG. 6 illustrates an exemplary operation of an electronic device providing a notification in accordance with a risk region.

Referring to FIG. 6, a vehicle 115 may include a steering wheel 610 and a display 208. For example, an electronic device 200 may transmit notification information to the display 208 through a communication interface 205. For example, the electronic device 200 may transmit, through the communication interface 205 to the display 208, a screen signal causing the display 208 to display a screen representing the notification information on the display 208. For example, the display 208 may receive the notification information from the electronic device 200. For example, the display 208 may receive the screen signal from the electronic device 200. For example, the display 208 may display the screen representing the notification information on the display 208 based on receiving the notification information. For example, the display 208 may display the screen representing the notification information on the display 208 based on receiving the screen signal. For example, based on determining that an external object 450 is included in a risk region 520, the electronic device 200 may generate an image including a visual object 625 corresponding to the external object 450, another visual object representing the risk region 520, and a visual representation (not illustrated) highlighting the visual object 625, using a video obtained through a camera 209. For example, the electronic device 200 may transmit a signal causing the display 208 to output the image to the display 208 included in the vehicle 115 through the communication interface 205.

For example, the display 208 may display the visual object 615 representing the vehicle 115. For example, the display 208 may display a visual object 620 representing the risk region 520. For example, the display 208 may display the visual object 625 representing the external object 450. For example, the display 208 may display a visual representation (not illustrated) indicating that the visual object 625 corresponding to the external object 450 is included in the risk region 520. For example, the visual representation may include a form of highlighting the visual object 625.

According to an embodiment, the vehicle 115 may include a speaker 210. For example, the electronic device 200 may transmit, through the communication interface 205 to the speaker 210, an audio signal causing the speaker 210 to output an audio 630 indicating that the external object 450 is included in the risk region 520, based on determining that the external object 450 is included in the risk region 520. For example, the speaker 210 may output the audio 630 indicating that the external object 450 is included in the risk region 520 based on receiving the audio signal. For example, the audio 630 may include a voice. For example, the audio 630 may include a sound effect. For example, the audio 630 may include a warning sound. For example, the electronic device 200 may transmit the notification information to the speaker 210. For example, the speaker 210 may output the audio 630 based on receiving the notification information. For example, the speaker 210 may output the audio 630 using the notification information.

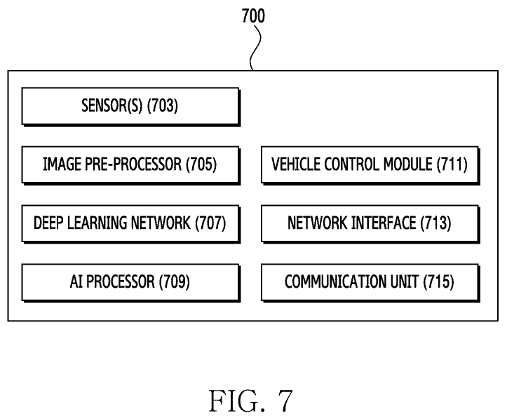

According to an embodiment, the electronic device 200 may generate notification information with respect to the external object 450. The electronic device 200 may transmit the notification information to an external electronic device (e.g., an autonomous driving system 700 of FIG. 7) for autonomous driving through the communication interface 205. For example, the vehicle 115 may include the external electronic device (e.g., the autonomous driving system 700 of FIG. 7) for autonomous driving. For example, the external electronic device for autonomous driving may receive the notification information. For example, the external electronic device may use the received notification information for autonomous driving. For example, the external electronic device may control the vehicle 115 to avoid the external object 450 using the notification information. For example, the external electronic device may control the steering wheel 610 of the vehicle 115 so that the vehicle 115 avoids the external object 450 using the notification information. For example, the external electronic device may control a brake of the vehicle 115 to prevent the vehicle 115 from colliding with the external object 450, using the notification information. For example, the electronic device 200 may receive a signal to control a moving direction and braking of the vehicle 115 from the external electronic device through the communication interface 205.

According to an embodiment, the electronic device 200 may transmit the generated notification information with respect to the external object 450 based on determining that the external object 450 is included in the risk region 520 to the external electronic device for autonomous driving through the communication interface 205. For example, the external electronic device may control a driving of the vehicle 115 using the notification information. However, it is not limited thereto. For example, the external electronic device may provide the electronic device 200 with a rotation angle of the steering wheel 610 that causes the external object 450 not to be included in the risk region 520, using the notification information. For example, the notification information may include rotation information of the steering wheel 610. For example, the external electronic device may determine a rotation angle adaptive to a road on which the vehicle 115 is driving by learning the rotation angle of the steering wheel 610. For example, the external electronic device may determine the rotation angle of the steering wheel 610 using information on the road on which the vehicle 115 is driving and the notification information. For example, the external electronic device may transmit the determined rotation angle to the electronic device 200.

FIG. 7 illustrates an example of a block diagram illustrating an autonomous driving system of a vehicle according to an embodiment.

The autonomous driving system 700 of the vehicle according to FIG. 7 may be a deep learning network including sensors 703, an image pre-processor 705, a deep learning network 707, an artificial intelligence (AI) processor 709, a vehicle control module 711, a network interface 713, and a communication unit 715. In various embodiments, each element may be connected through various interfaces. For example, sensor data sensed and outputted by the sensors 703 may be fed to the image pre-processor 705. The sensor data processed by the image pre-processor 705 may be fed to the deep learning network 707 running on the AI processor 709. An output of the deep learning network 707 running by the AI processor 709 may be fed to the vehicle control module 711. Intermediate results of the deep learning network 707 running on the AI processor 709 may be fed to the AI processor 709. In various embodiments, the network interface 713 delivers autonomous driving route information and/or autonomous driving control commands for autonomous driving of the vehicle to internal block configurations, by performing communication with an electronic device (e.g., the electronic device 200 of FIG. 2) in the vehicle. In an embodiment, the network interface 713 may be used to transmit the sensor data obtained through the sensor(s) 703 to an external server. In some embodiments, the autonomous driving control system 700 may include additional or fewer components as appropriate. For example, in some embodiments, the image pre-processor 705 may be an optional component. For another example, a post-processing component (not illustrated) may be included in the autonomous driving control system 700 to perform post-processing on the output of the deep learning network 707 before the output is provided to the vehicle control module 711.

In some embodiments, the sensors 703 may include one or more sensors. In various embodiments, the sensors 703 may be attached to different locations of the vehicle. The sensors 703 may face one or more different directions. For example, the sensors 703 may be attached to a front, sides, a rear, and/or a roof of the vehicle to face directions such as forward-facing, rear-facing, and side-facing. In some embodiments, the sensors 703 may be image sensors such as high dynamic range cameras. In some embodiments, the sensors 703 include non-visual sensors. In some embodiments, the sensors 703 include RADAR, Light Detection And Ranging (LiDAR), and/or ultrasonic sensors in addition to an image sensor. In some embodiments, the sensors 703 are not mounted on a vehicle having the vehicle control module 711. For example, the sensors 703 may be included as a portion of a deep learning system for capturing the sensor data and may be attached to an environment or a roadway and/or mounted on nearby vehicles.

In some embodiments, the image pre-processor 705 may be used to pre-process the sensor data of the sensors 703. For example, the image pre-processor 705 may be used to preprocess the sensor data, to split the sensor data into one or more components, and/or to post-process one or more components. In some embodiments, the image pre-processor 705 may be a graphics processing unit (GPU), a central processing unit (CPU), an image signal processor, or a specialized image processor. In various embodiments, the image pre-processor 705 may be a tone-mapper processor for processing high dynamic range data. In some embodiments, the image pre-processor 705 may be a component of the AI processor 709.

In some embodiments, the deep learning network 707 may be a deep learning network for implementing control commands for controlling an autonomous vehicle. For example, the deep learning network 707 may be an artificial neural network such as a convolution neural network (CNN) trained by using the sensor data, and the output of the deep learning network 707 is provided to the vehicle control module 711.

In some embodiments, the artificial intelligence (AI) processor 709 may be a hardware processor for running the deep learning network 707. In some embodiments, the AI processor 709 is a specialized AI processor for performing inference on the sensor data through the convolution neural network (CNN). In some embodiments, the AI processor 709 may be optimized for a bit depth of the sensor data. In some embodiments, the AI processor 709 may be optimized for deep learning computations, such as computations of a neural network including a convolution, a dot product, a vector and/or matrix computations. In some embodiments, the AI processor 709 may be implemented through a plurality of graphics processing units (GPUs) capable of effectively performing parallel processing.

In various embodiments, the AI processor 709 may be coupled, through an input/output interface, to memory configured to perform a deep learning analysis on the sensor data received from the sensor(s) 703 while the AI processor 709 is running and to provide an AI processor having commands that cause to determine a machine learning result used to operate the vehicle at least partially autonomously. In some embodiments, the vehicle control module 711 may be used to process commands for vehicle control outputted from the artificial intelligence (AI) processor 709 and translate the output of the AI processor 709 into commands for controlling a module of each vehicle to control various modules of the vehicle. In some embodiments, the vehicle control module 711 is used to control a vehicle for autonomous driving. In some embodiments, the vehicle control module 711 may adjust steering and/or speed of the vehicle. For example, the vehicle control module 711 may be used to control traveling of the vehicle such as deceleration, acceleration, steering, lane change, lane keeping, and the like. In some embodiments, the vehicle control module 711 may generate control signals for controlling vehicle lighting, such as brake lights, turns signals, headlights, and the like. In some embodiments, the vehicle control module 711 may be used to control vehicle audio-related systems such as a vehicle's sound system, vehicle's audio warnings, a vehicle's microphone system, a vehicle's horn system, and the like.

In some embodiments, the vehicle control module 711 may be used to control notification systems, including warning systems to notify passengers and/or a driver of driving events, such as approach of an intended destination or a potential collision. In some embodiments, the vehicle control module 711 may be used to adjust sensors, such as the sensors 703 of the vehicle. For example, the vehicle control module 711 may modify the orientation of the sensors 703, change output resolution and/or a format type of the sensors 703, increase or decrease a capture rate, adjust a dynamic range, and adjust a focus of the camera. In addition, the vehicle control module 711 may turn on/off the operation of sensors individually or collectively.

In some embodiments, the vehicle control module 711 may be used to change parameters of the image pre-processor 705 in a method such as modifying a frequency range of filters, adjusting features and/or edge detection parameters for object detection, or adjusting channels and a bit depth, and the like. In various embodiments, the vehicle control module 711 may be used to control autonomous driving of the vehicle and/or a driver assistance function of the vehicle.

In some embodiments, the network interface 713 may be responsible for an internal interface between block configurations of the autonomous driving control system 700 and the communication unit 715. Specifically, the network interface 713 may be a communication interface for receiving and/or transmitting data including voice data. According to various embodiments, the network interface 713 may be connected to external servers to connect voice calls, receive and/or transmit text messages, transmit sensor data, update software of the vehicle with the autonomous driving system, or update software of the autonomous driving system of the vehicle, through the communication unit 715.

In various embodiments, the communication unit 715 may include various wireless interfaces of cellular or WiFi methods. For example, the network interface 713 may be used to receive an update on operating parameters and/or commands for the sensors 703, the image pre-processor 705, the deep learning network 707, the AI processor 709, and the vehicle control module 711 from an external server connected through the communication unit 715. For example, a machine learning model of the deep learning network 707 may be updated by using the communication unit 715. According to another example, the communication unit 715 may be used to update operating parameters of the image pre-processor 705, such as image processing parameters, and/or firmware of the sensors 703.

In another embodiment, the communication unit 715 may be used to activate communications for an emergency contact and emergency services in an accident or near-accident event. For example, in a crash event, the communication unit 715 may be used to call emergency services for assistance and may be used to externally notify emergency services of crash details and a location of the vehicle. In various embodiments, the communication unit 715 may update or obtain an expected arrival time and/or a destination location.

According to an embodiment, the autonomous driving system 700 illustrated in FIG. 7 may be configured with an electronic device 200 of the vehicle. According to an embodiment, when an autonomous driving release event occurs from a user during autonomous driving of the vehicle, the AI processor 709 of the autonomous driving system 700 may control the software of the vehicle autonomous driving to learn by controlling information related to the autonomous driving release event to be inputted as training set data of the deep learning network.

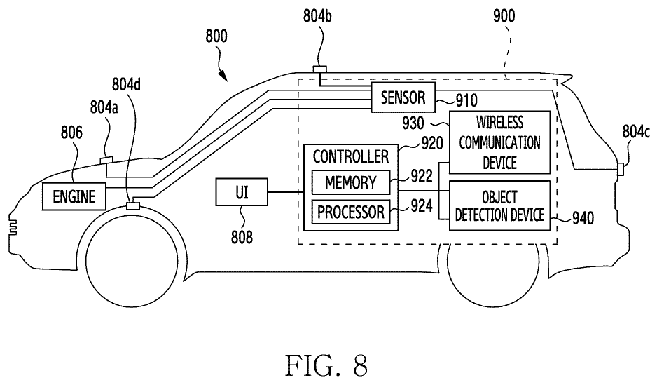

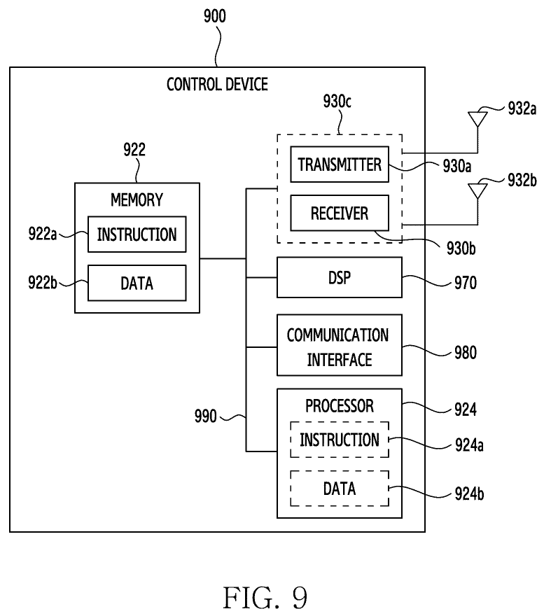

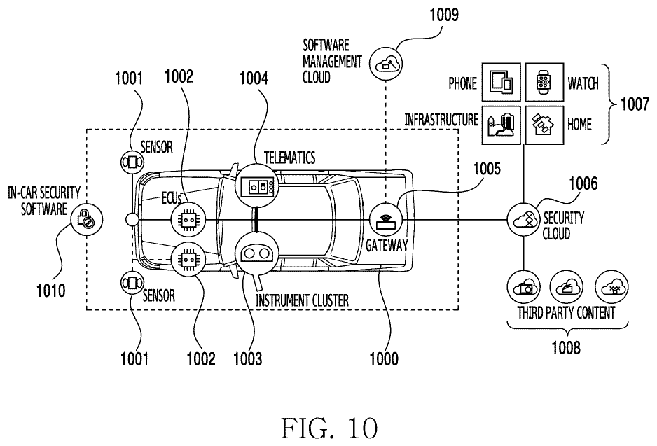

FIGS. 8 and 9 illustrate an example of a block diagram indicating an autonomous driving moving object according to an embodiment. FIG. 10 illustrates an example of a gateway related to a user device according to various embodiments.

Referring to FIG. 8, an autonomous moving object 800 according to the present embodiment may include a control device 900, sensing modules 804a, 804b, 804c, and 804d, an engine 806, and a user interface 808.

The autonomous driving moving object 800 may have an autonomous driving mode or a manual mode. As an example, according to a user input received through the user interface 808, it may be switched from the manual mode to the autonomous driving mode or may be switched from the autonomous driving mode to the manual mode.

In case that the moving object 800 operates in the autonomous driving mode, the autonomous driving moving object 800 may operate under control of the control device 900.

In the present embodiment, the control device 900 may include a controller 920, including memory 922 and a processor 924, a sensor 910, a communication device 930, and an object detection device 940.

Herein, the object detection device 940 may perform all or a portion of a function of a distance measurement device.

That is, in the present embodiment, the object detection device 940 is a device for detecting an object located outside the moving object 800, and the object detection device 940 may detect the object located outside the moving object 800 and generate object information according to the detection result.

The object information may include information on existence or nonexistence of the object, location information of the object, distance information between the moving object and the object, and relative speed information between the moving object and the object.

The object may include various objects located outside the moving object 800, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 940 may include a camera module. The controller 920 may extract object information from an external image photographed by the camera module and enable the controller 920 to process information thereon.

In addition, the object detection device 940 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection. Meanwhile, the distance measurement device according to an embodiment of the present invention may calculate a distance between the autonomous driving moving object 800 and the object, and may control an operation of the moving object based on the distance calculated in connection with the control device 900 of the autonomous driving moving object 800.

As an example, in case that there is a probability of a collision according to the distance between the autonomous driving moving object 800 and the object, the autonomous driving moving object 800 may control a brake to lower a speed or stop. As another example, in case that the object is a moving object, the autonomous driving moving object 800 may control a traveling speed of the autonomous driving moving object 800 to maintain a predetermined distance or more from the object.

This distance measurement device according to an embodiment of the present invention may be configured as a module in the control device 900 of the autonomous driving moving object 800. That is, the memory 922 and the processor 924 of the control device 900 may be configured to implement a collision prevention method according to the present invention in software.

In addition, the sensor 910 may obtain various sensing information by connecting an internal/external environment of the moving object with the sensing modules 804a, 804b, 804c, and 804d. Herein, the sensor 910 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 910 may obtain sensing signals for moving object posture information, moving object collision information, moving object direction information, moving object location information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 910 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 910 may generate moving object state information based on sensing data.

The wireless communication device 930 is configured to implement wireless communication between the autonomous driving moving object 800. For example, it enables the autonomous driving moving object 800 to communicate with a mobile phone of a user, or the other wireless communication device 930, another moving object, a central device (a traffic control device), a server, and the like. The wireless communication device 930 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 800 to implement communication between moving objects through the wireless communication device 930. That is, the wireless communication device 930 may perform communication with another moving object and other moving objects on the road through vehicle-to-vehicle (V2V) communication. The autonomous driving moving object 800 may transmit and receive information such as driving warning and traffic information through the vehicle-to-vehicle (V2V) communication, and it is also possible to request information from, or receive a request from the other moving object. For example, the wireless communication device 930 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 930.

In addition, the wireless communication device 930 may obtain information generated from various mobilities, including infrastructure (a traffic light, a CCTV, a RSU, a eNode B, and the like) located on the road or other autonomous driving/non-autonomous driving vehicles, and the like, through a non-terrestrial network other than a terrestrial network, as information for autonomous driving performance of the autonomous driving moving object 800.

For example, the wireless communication device 930 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 800.

For example, the wireless communication device 930 may perform wireless communication with various platforms configuring the NTN according to a 5TH Generation New Radio Non-Terrestrial Network (5G NR NTN) standard, which is currently discussed in 3GPP, and the like, but is not limited thereto.

In the present embodiment, the controller 920 may select a platform that may properly perform NTN communication in consideration of various information such as a location of the autonomous driving moving object 800, current time, and available power, and control the wireless communication device 930 to perform wireless communication with the selected platform.

In the present embodiment, the controller 920, which is a unit that controls an overall operation of each unit in the moving object 800, may be configured by a manufacturer of the moving object when manufacturing or may be additionally configured to perform a function of autonomous driving after manufacturing. In addition, a configuration for performing a continuous additional function may be included through an upgrade of the controller 920 configured when manufacturing. This controller 920 may also be named an Electronic Control Unit (ECU).

The controller 920 may collect various data from the connected sensor 910, the object detection device 940, the communication device 930, and may transmit a control signal to the sensor 910, the engine 806, the user interface 808, the communication device 930, and the object detection device 940 included in other components in the moving object based on the collected data. In addition, although not illustrated, the control signal may also be transmitted to an acceleration device, a braking system, a steering device, or a navigation device related to traveling of the moving object.

In the present embodiment, the controller 920 may control the engine 806, for example, may detects a speed limit of a road on which the autonomous driving moving object 800 is traveling, and may control the engine 806 so that a traveling speed does not exceed the speed limit or may control the engine 806 to accelerate the traveling speed of the autonomous driving moving object 800 in a range that does not exceed the speed limit.

In addition, when the autonomous driving moving object 800 approaches a lane or leaves the lane while the autonomous driving moving object 800 is traveling, the controller 920 may determine whether such lane approaching and leaving are due to a normal traveling situation or another traveling situation, and may control the engine 806 to control the traveling of the moving object according to the determination result. Specifically, the autonomous driving moving object 800 may detect lanes formed on both sides of the lane in which the moving object is traveling. In this case, the controller 920 may determine whether the autonomous driving moving object 800 approaches the lane or leaves the lane, and if it is determined that the autonomous driving moving object 800 approaches the lane or leaves the lane, the controller 920 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 800 is approaching the lane or leaving the lane in a situation in which the moving object does not need to change lane, the controller 920 may control the traveling of the autonomous driving moving object 800 so that the autonomous driving moving object 800 does not leave the lane and normally travels in a corresponding vehicle.

In case that another moving object or an obstacle exists in a front of the moving object, it may control the engine 806 or the braking system to decelerate the driving moving object, and may control a trajectory, a traveling route, and a steering angle in addition to speed. Alternatively, the controller 920 may control the traveling of the moving object by generating a necessary control signal according to recognition information of another external environment, such as a traveling lane or a driving signal of the moving object.

In addition to generating its own control signal, the controller 920 may also control the traveling of the moving object by performing communication with a nearby moving object or a central server and transmitting a command to control peripheral devices through the received information.

In addition, since accurate recognition of the moving object or lane according to the present embodiment may be difficult in case that a location of the camera module changes or an angle of view changes, the controller 920 may generate a control signal for controlling to perform calibration of the camera module to prevent this. Therefore, in the present embodiment, by generating the calibration control signal to the camera module, the controller 920 may continuously maintain a normal mounting location, a direction, an angle of view, and the like of the camera module even when a mounting location of the camera module is changed due to vibration or impact generated by a movement of the autonomous driving moving object 800. In case that an initial mounting location, a direction, and an angle of view information of the camera module that are pre-stored, and an initial mounting location, a direction, an angle of view information, and the like of the camera module measured while the autonomous driving moving object 800 is traveling are changed by a threshold value or more, the controller 920 may generate the control signal to perform the calibration of the camera module.

In the present embodiment, the controller 920 may include the memory 922 and the processor 924. The processor 924 may execute software stored in the memory 922 according to the control signal of the controller 920. Specifically, the controller 920 may store data and commands for performing the lane detection method according to the present invention in the memory 922, and the commands may be executed by the processor 924 to implement one or more methods disclosed herein.

In this case, the memory 922 may be stored in a recording medium executable by the non-volatile processor 924. The memory 922 may store software and data through an appropriate internal/external device. The memory 922 may be configured with random access memory (RAM), read only memory (ROM), a hard disk, and a memory 922 device connected with a dongle.

The memory 922 may at least store an Operating system (OS), a user application, and executable commands. The memory 922 may also store application data and array data structures.

The processor 924, which is a microprocessor or an appropriate electronic processor, may be a controller, a microcontroller, or a state machine.

The processor 924 may be implemented as a combination of computing devices, and the computing device may be configured with a digital signal processor, a microprocessor, or an appropriate combination thereof.

Meanwhile, the autonomous driving moving object 800 may further include the user interface 808 for a user input with respect to the above-described control device 900. The user interface 808 may enable a user to input information with appropriate interaction. For example, it may be implemented as a touch screen, a keypad, or an operation button, and the like. The user interface 808 may transmit an input or a command to the controller 920, and the controller 920 may perform a control operation of the moving object in response to the input or the command.

In addition, the user interface 808, which is a device outside the autonomous driving moving object 800, may perform communication with the autonomous driving moving object 800 through the wireless communication device 930. For example, the user interface 808 may be linkable with a mobile phone, a tablet, or another computer device.

Furthermore, in the present embodiment, the autonomous driving moving object 800 has been described as including the engine 806, but it may also include another type of a propulsion system. For example, the moving object may be operated with electrical energy, and may be operated through hydrogen energy or a hybrid system combining them. Therefore, the controller 920 may include a propulsion mechanism according to the propulsion system of the autonomous driving moving object 800 and may provide a control signal according to this to components of each propulsion mechanism.

Hereinafter, a detailed configuration of the control device 900 according to the present invention according to the present embodiment will be described in more detail with reference to FIG. 9.

A control device 900 includes a processor 924. The processor 924 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 924 is used as a combination of a plurality of processors.

The control device 900 also includes memory 922. The memory 922 may be any electronic component capable of storing electronic information. The memory 922 may also include a combination of the memories 922 in addition to single memory.

Data and commands 922a for performing a distance measuring method of a distance measuring device according to the present invention may be stored in the memory 922. When the processor 924 executes the commands 922a, all or a portion of the commands 922a and the data 922b required for performing a command may be loaded 924a and 924b onto the processor 924.

The control device 900 may include a transmitter 930a, a receiver 930b, or a transceiver 930c for permitting transmission and reception of signals. One or more antennas 932a and 932b may be electrically connected to the transmitter 930a, the receiver 930b, or each transceiver 930c, and may further include antennas.

The control device 900 may include a digital signal processor (DSP) 970. Through the DSP 970, the digital signal may be quickly processed by a moving object.

The control device 900 may include a communication interface 980. The communication interface 980 may include one or more ports and/or communication modules for connecting other devices to the control device 900. The communication interface 980 may enable a user and the control device 900 to interact with each other.

Various configurations of the control device 900 may be connected together by one or more buses 990, and the buses 990 may include a power bus, a control signal bus, a state signal bus, a data bus, and the like. Under a control of the processor 924, configurations may transmit mutual information through the bus 990 and perform a desired function. Meanwhile, in various embodiments, the control device 900 may be related to a gateway for communication with a security cloud. For example, referring to FIG. 10, the control device 900 may be related to a gateway 1005 for providing information obtained from at least one of components 1001 to 1004 of a vehicle 1000 to a security cloud 1006. For example, the gateway 1005 may be included in the control device 900. For another example, the gateway 1005 may be configured as a separate device in the vehicle 1000 that is distinguished from the control device 900. The gateway 1005 connects a network in the vehicle 1000 secured by a software management cloud 1009, the security cloud 1006, and in-car security software 1010, having different networks, to enable communication.

For example, a component 1001 may be a sensor. For example, the sensor may be used to obtain information on at least one of a state of the vehicle 1000 or a state around the vehicle 1000. For example, the component 1001 may include a sensor 910.

For example, a component 1002 may be electronic control units (ECUs). For example, the ECUs may be used for engine control, transmission control, airbag control, and tire pressure management.

For example, a component 1003 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1000, visual elements for indicating an amount of remaining fuel, visual elements for indicating a state of a gear, or visual elements for indicating information obtained through the component 1001.

For example, a component 1004 may be a telematics device. For example, the telematics device may mean a device that provides various mobile communication services, such as location information and safe driving in the vehicle 1000 by coupling wireless communication technology and global positioning system (GPS) technology. For example, the telematics device may be used to connect the vehicle 1000 with a driver, a cloud (e.g., the security cloud 1006), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1000.

For example, the gateway 1005 may be used to connect a network within the vehicle 1000, and the software management cloud 1009 and the secure cloud 1006, which are a network outside the vehicle. For example, the software management cloud 1009 may be used to update or manage at least one software necessary for traveling and managing the vehicle 1000. For example, the software management cloud 1009 may be linked to the in-car security software 1010 installed in the vehicle. For example, the in-car security software 1010 may be used to provide a security function in the vehicle 1000. For example, the in-car security software 1010 may encrypt data transmitted and received through an in-car network using an encryption key obtained from an external authorized server for encryption of the in-car network. In various embodiments, the encryption key used by the in-car security software 1010 may be generated corresponding to vehicle identification information (a vehicle license plate, a vehicle identification number (VIN)) or information (e.g., user identification information) uniquely assigned to each user.

In various embodiments, the gateway 1005 may transmit the data encrypted by the in-car security software 1010 based on the encryption key to the software management cloud 1009 and/or the security cloud 1006. The software management cloud 1009 and/or the security cloud 1006 may identify the data received from which vehicle or which user by decrypting the data encrypted by the encryption key of the in-car security software 1010. For example, since the decryption key is a unique key corresponding to the encryption key, the software management cloud 1009 and/or the security cloud 1006 may identify a transmission entity (e.g., the vehicle or the user) of the data based on the data decrypted through the decryption key.

For example, the gateway 1005 may be configured to support in-car security software 1010 and may be related to the control device 900. For example, the gateway 1005 may be related to the control device 900 to support a connection between a client device 1007 and the control device 900 connected to the security cloud 1006. For another example, the gateway 1005 may be related to the control device 900 to support a connection between a third-party cloud 1008 connected to the security cloud 1006 and the control device 900. However, it is not limited thereto.

In various embodiments, the gateway 1005 may be used to connect the vehicle 1000 with the software management cloud 1009 to manage operating software of the vehicle 1000. For example, the software management cloud 1009 may monitor whether updating the operating software of the vehicle 1000 is required, and based on monitoring that the updating the operating software of the vehicle 1000 is required, provide data for the updating the operating software of the vehicle 1000 through the gateway 1005. For another example, the software management cloud 1009 may receive a user request for updating the operating software of the vehicle 1000 from the vehicle 1000 through the gateway 1005, and provide data for updating the operating software of the vehicle 1000 based on the reception. However, it is not limited thereto.

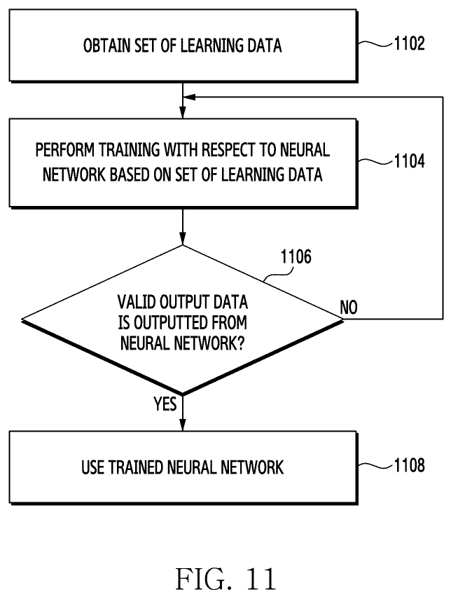

FIG. 11 is a diagram for explaining an operation of an electronic device for training a neural network based on a set of learning data, according to an embodiment.

An operation described with reference to FIG. 11 may be performed by the above-described electronic device (e.g., the electronic device 200 of FIG. 2).

Referring to FIG. 11, in operation 1102, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1102 may include pairs of a plurality of learning data. In the example of training the neural network for the image recognition, the set of the learning data identified by the electronic device may include a plurality of images and ground truth data corresponding to each of the plurality of images.

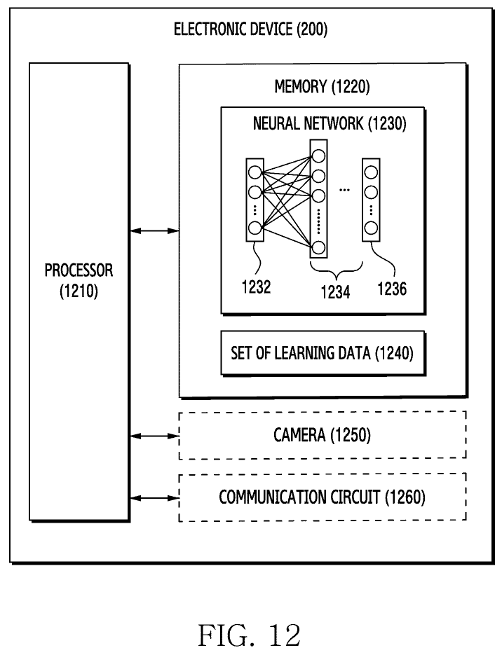

Referring to FIG. 11, in operation 1104, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 12. From an output layer of the neural network receiving the input data through the input layer, the electronic device may obtain output data of the neural network corresponding to the input data.

In an embodiment, the training of the operation 1104 may be performed based on a difference between the output data and the ground truth data included in the learning data and corresponding to the input data. For example, the electronic device may adjust one or more parameters related to the neural network (e.g., a weight to be described later with reference to FIG. 12) to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

Referring to FIG. 11, in operation 1106, according to an embodiment, the electronic device may identify whether valid output data is outputted from the neural network trained by the operation 1104. The output data being valid may mean that the difference (or the cost function) between the output data and the ground truth data satisfies a condition set for use of the neural network. For example, in case that an average value and/or the maximum value of the difference between the output data and the ground truth data is less than or equal to a designated threshold value, the electronic device may determine that the valid output data is outputted from the neural network.

In case that the valid output data is not outputted from the neural network (1106-NO), the electronic device may repeatedly perform training of the neural network based on the operation 1104. An embodiment is not limited thereto, and the electronic device may repeatedly perform the operations 1102 and 1104.

In a state in which the valid output data is obtained from the neural network (1106-YES), based on operation 1108, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

FIG. 12 is a block diagram of an electronic device according to an embodiment.

An electronic device 200 of FIG. 12 may include the above-described electronic device.

For example, an operation described with reference to FIG. 11 may be performed by the electronic device 200 of FIG. 12 and/or a processor 1210 of FIG. 12.

Referring to FIG. 12, the processor 1210 of the electronic device 200 may perform computations related to a neural network 1230 stored in memory 1220. The processor 1210 may include at least one of a center processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 12, the processor 1210 may identify the neural network 1230 stored in the memory 1220. The neural network 1230 may include a combination of an input layer 1232, one or more hidden layers 1234 (or intermediate layers), and an output layer 1236. The above-described layers (e.g., the input layer 1232, the one or more hidden layers 1234, and the output layer 1236) may include a plurality of nodes. The number of hidden layers 1234 may vary according to an embodiment, and the neural network 1230 including the plurality of hidden layers 1234 may be referred to as a deep neural network. An operation of training the deep neural network may be referred to as deep learning.

In an embodiment, in case that the neural network 1230 has a structure of a feed forward neural network, a first node included in a specific layer may be connected to all of second nodes included in another layer before the specific layer. In the memory 1220, parameters stored for the neural network 1230 may include weights assigned to connections between the second nodes and the first node. In the neural network 1230 having the structure of the feed forward neural network, a value of the first node may correspond to a weighted sum of values assigned to the second nodes, based on the weights assigned to the connections connecting the second nodes and the first node.

In an embodiment, in case that the neural network 1230 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1220, the parameters stored for the neural network 1230 may include weights indicating the filter. The filter may include, among the second nodes, one or more nodes to be used to calculate a weighted sum of the first node, and weights corresponding to each of the one or more nodes.

According to an embodiment, the processor 1210 of the electronic device 200 may perform training on the neural network 1230 using a learning data set 1240 stored in the memory 1220. Based on the learning data set 1240, the processor 1210 may adjust one or more parameters stored in the memory 1220 for the neural network 1230 by performing the operation described with reference to FIG. 11.

According to an embodiment, the processor 1210 of the electronic device 200 may perform object detection, object recognition, and/or object classification using the neural network 1230 trained based on the learning data set 1240. The processor 1210 may input an image (or a video) obtained through a camera 1250 into the input layer 1232 of the neural network 1230. Based on the input layer 1232 to which the image is inputted, the processor 1210 may obtain a set (e.g., the output data) of values of the nodes of the output layer 1236 by sequentially obtaining values of the nodes of the layers included in the neural network 1230. The output data may be used as a result of inferring information included in the image using the neural network 1230. An embodiment is not limited thereto, and the processor 1210 may input an image (or a video) obtained from an external electronic device connected to the electronic device 200 through communication circuitry 1260 to the neural network 1230.

In an embodiment, the neural network 1230 trained to process an image may be used to identify a region corresponding to a subject within the image (object detection), and/or to identify a class of the subject represented within the image (object recognition and/or object classification). For example, the electronic device 200 may segment the region corresponding to the subject within the image based on a quadrangle shape such as a bounding box, using the neural network 1230. For example, the electronic device 200 may identify at least one class matching the subject among a plurality of designated classes using the neural network 1230.

As described above, an electronic device (e.g., the electronic device 200) in a vehicle (e.g., the vehicle 115), may comprise memory (e.g., the memory 206) storing instructions. The electronic device may comprise a communication interface (e.g., the communication interface 205). The electronic device may comprise at least one processor (e.g., at least one processor 207). The instructions, when executed by the at least one processor individually or collectively, may cause the electronic device to receive, via the communication interface, from a camera included in the vehicle, a video with respect to a peripheral environment of the vehicle. The instructions, when executed by the at least one processor individually or collectively, may cause the electronic device to, using the video, obtain position information with respect to an external object included in the peripheral environment. The instructions, when executed by the at least one processor individually or collectively, may cause the electronic device to receive, via the communication interface, from a wheel sensor included in the vehicle, rotation information indicating an angle of a steering wheel in the vehicle. The instructions, when executed by the at least one processor individually or collectively, may cause the electronic device to, using the rotation information and the position information, determine whether the external object is included in a risk region expected to be occupied by the vehicle moving in accordance with the angle. The instructions, when executed by the at least one processor individually or collectively, may cause the electronic device to, based on determining that the external object is included in the risk region, generate notification information with respect to the external object.

According to an embodiment, the instructions, when executed by the at least one processor individually or collectively, may cause the electronic device to, based on determining that the external object is included in the risk region, using the video, generate an image including a visual object corresponding to the external object, another visual object representing the risk region, and a visual representation highlighting the visual object. The instructions, when executed by the at least one processor individually or collectively, may cause the electronic device to transmit, via the communication interface to a display included in the vehicle, a signal causing the display to output the image.

According to an embodiment, the instructions, when executed by the at least one processor individually or collectively, may cause the electronic device to, based on determining that the external object is included in the risk region, transmit, via the communication interface to a speaker, a signal causing the speaker to output an audio indicating that the external object is included in the risk region.

According to an embodiment, the instructions, when executed by the at least one processor individually or collectively, may cause the electronic device to transmit, via the communication interface to an external electronic device, included in the vehicle, for autonomous driving, the notification information.

According to an embodiment, the instructions, when executed by the at least one processor individually or collectively, may cause the electronic device to receive, via the communication interface from the external electronic device, a signal to control a moving direction and braking of the vehicle.

According to an embodiment, the vehicle may include a tractor capable of towing a trailer. The instructions, when executed by the at least one processor individually or collectively, may cause the electronic device to, using trailer information indicating a length of a trailer connected to the tractor, determine the risk region with respect to the tractor and the trailer.

According to an embodiment, the instructions, when executed by the at least one processor individually or collectively, may cause the electronic device to, further using a distance between the vehicle and the external object obtained by performing a back-projection with respect to a visual object, included in the video, corresponding to the external object, determine whether the external object is included in the risk region.

According to an embodiment, the instructions, when executed by the at least one processor individually or collectively, may cause the electronic device to, using the video and a pretrained model, identify a type of a visual object corresponding to the external object included in the peripheral environment. The instructions, when executed by the at least one processor individually or collectively, may cause the electronic device to, using the type, determine whether the external object is allowed to be included in the risk region.

According to an embodiment, the instructions, when executed by the at least one processor individually or collectively, may cause the electronic device to, based on identifying the risk region including a blind spot of the camera, using an ultrasonic sensor arranged toward the blind spot, detect another external object positioned in the risk region.

As described above, a method executed in an electronic device (e.g., the electronic device 200), having a communication interface (e.g., the communication interface 205), in a vehicle, may comprise receiving, via the communication interface, from a camera included in the vehicle, a video with respect to a peripheral environment of the vehicle. The method may comprise, by using the video, obtaining position information with respect to an external object included in the peripheral environment. The method may comprise receiving, via the communication interface, from a wheel sensor included in the vehicle, rotation information indicating an angle of a steering wheel in the vehicle. The method may comprise, by using the rotation information and the position information, determining whether the external object is included in a risk region expected to be occupied by the vehicle moving in accordance with the angle. The method may comprise, based on determining that the external object is included in the risk region, generating notification information with respect to the external object.

According to an embodiment, the method may comprise, based on determining that the external object is included in the risk region, by using the video, generating an image including a visual object corresponding to the external object, another visual object representing the risk region, and a visual representation highlighting the visual object. The method may comprise transmitting, via the communication interface to a display included in the vehicle, a signal causing the display to output the image.

According to an embodiment, the method may comprise, based on determining that the external object is included in the risk region, transmitting, via the communication interface to a speaker, a signal causing the speaker to output an audio indicating that the external object is included in the risk region.

According to an embodiment, the method may comprise transmitting, via the communication interface to an external electronic device, included in the vehicle, for autonomous driving, the notification information.

According to an embodiment, the method may comprise receiving, via the communication interface from the external electronic device, a signal to control a moving direction and braking of the vehicle.

According to an embodiment, the vehicle may include a tractor capable of towing a trailer. The method may comprise, using trailer information indicating a length of a trailer connected to the tractor, determining the risk region with respect to the tractor and the trailer.

According to an embodiment, the method may comprise, further using a distance between the vehicle and the external object obtained by performing a back-projection with respect to a visual object, included in the video, corresponding to the external object, determining whether the external object is included in the risk region.

According to an embodiment, the method may comprise, using the video and a pretrained model, identifying a type of a visual object corresponding to the external object included in the peripheral environment. The method may comprise, using the type, determining whether the external object is allowed to be included in the risk region.

According to an embodiment, the method may comprise, based on identifying the risk region including a blind spot of the camera, using an ultrasonic sensor arranged toward the blind spot, detecting another external object positioned in the risk region.

As described above, in a non-transitory computer readable storage medium in which one or more programs are stored, the one or more programs may comprise instructions to, when executed by an electronic device (e.g., the electronic device 200), having a communication interface (e.g., the communication interface 205), in a vehicle, cause the electronic device to receive, via the communication interface, from a camera included in the vehicle, a video with respect to a peripheral environment of the vehicle. The one or more programs may comprise instructions to, when executed by the electronic device, cause the electronic device to, using the video, obtain position information with respect to an external object included in the peripheral environment. The one or more programs may comprise instructions to, when executed by the electronic device, cause the electronic device to receive, via the communication interface, from a wheel sensor included in the vehicle, rotation information indicating an angle of a steering wheel in the vehicle. The one or more programs may comprise instructions to, when executed by the electronic device, cause the electronic device to, using the rotation information and the position information, determine whether the external object is included in a risk region expected to be occupied by the vehicle moving in accordance with the angle. The one or more programs may comprise instructions to, when executed by the electronic device, cause the electronic device to, based on determining that the external object is included in the risk region, generate notification information with respect to the external object.

According to an embodiment, the one or more programs may comprise instructions to, when executed by the electronic device, cause the electronic device to, based on determining that the external object is included in the risk region, using the video, generate an image including a visual object corresponding to the external object, another visual object representing the risk region, and a visual representation highlighting the visual object. The one or more programs may comprise instructions to, when executed by the electronic device, cause the electronic device to transmit, via the communication interface to a display included in the vehicle, a signal causing the display to output the image.

According to an embodiment, the one or more programs may comprise instructions to, when executed by the electronic device, cause the electronic device to, based on determining that the external object is included in the risk region, transmit, via the communication interface to a speaker, a signal causing the speaker to output an audio indicating that the external object is included in the risk region.

According to an embodiment, the one or more programs may comprise instructions to, when executed by the electronic device, cause the electronic device to transmit, via the communication interface to an external electronic device, included in the vehicle, for autonomous driving, the notification information.

According to an embodiment, the one or more programs may comprise instructions to, when executed by the electronic device, cause the electronic device to receive, via the communication interface from the external electronic device, a signal to control a moving direction and braking of the vehicle.

According to an embodiment, the vehicle may include a tractor capable of towing a trailer. The one or more programs may comprise instructions to, when executed by the electronic device, cause the electronic device to, using trailer information indicating a length of a trailer connected to the tractor, determine the risk region with respect to the tractor and the trailer.

According to an embodiment, the one or more programs may comprise instructions to, when executed by the electronic device, cause the electronic device to, further using a distance between the vehicle and the external object obtained by performing a back-projection with respect to a visual object, included in the video, corresponding to the external object, determine whether the external object is included in the risk region.

According to an embodiment, the one or more programs may comprise instructions to, when executed by the electronic device, cause the electronic device to, using the video and a pretrained model, identify a type of a visual object corresponding to the external object included in the peripheral environment. The one or more programs may comprise instructions to, when executed by the electronic device, cause the electronic device to, using the type, determine whether the external object is allowed to be included in the risk region.

According to an embodiment, the one or more programs may comprise instructions to, when executed by the electronic device, cause the electronic device to, based on identifying the risk region including a blind spot of the camera, using an ultrasonic sensor arranged toward the blind spot, detect another external object positioned in the risk region.

1. An electronic device in a vehicle, the electronic device comprising:
memory, comprising one or more storage mediums, storing instructions;
a communication interface; and
at least one processor comprising processing circuitry,
wherein the instructions, when executed by the at least one processor individually or collectively, cause the electronic device to:
receive, via the communication interface, from a camera included in the vehicle, a video with respect to a peripheral environment of the vehicle,
using the video, obtain position information with respect to an external object included in the peripheral environment,
receive, via the communication interface, from a wheel sensor included in the vehicle, rotation information indicating an angle of a steering wheel in the vehicle,
using the rotation information and the position information, determine whether the external object is included in a risk region expected to be occupied by the vehicle moving in accordance with the angle, and
based on determining that the external object is included in the risk region, generate notification information with respect to the external object.

2. The electronic device of claim 1, wherein the instructions, when executed by the at least one processor individually or collectively, cause the electronic device to:
based on determining that the external object is included in the risk region, using the video, generate an image including a visual object corresponding to the external object, another visual object representing the risk region, and a visual representation highlighting the visual object, and
transmit, via the communication interface to a display included in the vehicle, a signal causing the display to output the image.

3. The electronic device of claim 1, wherein the instructions, when executed by the at least one processor individually or collectively, cause the electronic device to:
based on determining that the external object is included in the risk region, transmit, via the communication interface to a speaker, a signal causing the speaker to output an audio indicating that the external object is included in the risk region.

4. The electronic device of claim 1, wherein the instructions, when executed by the at least one processor individually or collectively, cause the electronic device to:
transmit, via the communication interface to an external electronic device, included in the vehicle, for autonomous driving, the notification information.

5. The electronic device of claim 4, wherein the instructions, when executed by the at least one processor individually or collectively, cause the electronic device to:
receive, via the communication interface from the external electronic device, a signal to control a moving direction and braking of the vehicle.

6. The electronic device of claim 1, wherein the vehicle includes a tractor capable of towing a trailer, and
wherein the instructions, when executed by the at least one processor individually or collectively, cause the electronic device to:
using trailer information indicating a length of a trailer connected to the tractor, determine the risk region with respect to the tractor and the trailer.

7. The electronic device of claim 1, wherein the instructions, when executed by the at least one processor individually or collectively, cause the electronic device to:
further using a distance between the vehicle and the external object obtained by performing a back-projection with respect to a visual object, included in the video, corresponding to the external object, determine whether the external object is included in the risk region.

8. The electronic device of claim 1, wherein the instructions, when executed by the at least one processor individually or collectively, cause the electronic device to:
using the video and a pretrained model, identify a type of a visual object corresponding to the external object included in the peripheral environment, and
using the type, determine whether the external object is allowed to be included in the risk region.

9. The electronic device of claim 1, wherein the instructions, when executed by the at least one processor individually or collectively, cause the electronic device to:
based on identifying the risk region including a blind spot of the camera, using an ultrasonic sensor arranged toward the blind spot, detect another external object positioned in the risk region.

10. A non-transitory computer readable storage medium storing one or more programs, the one or more programs comprising instructions to, when executed by an electronic device, having a communication interface, in a vehicle, cause the electronic device to:
receive, via the communication interface, from a camera included in the vehicle, a video with respect to a peripheral environment of the vehicle,
using the video, obtain position information with respect to an external object included in the peripheral environment,
receive, via the communication interface, from a wheel sensor included in the vehicle, rotation information indicating an angle of a steering wheel in the vehicle,
using the rotation information and the position information, determine whether the external object is included in a risk region expected to be occupied by the vehicle moving in accordance with the angle, and
based on determining that the external object is included in the risk region, generate notification information with respect to the external object.

11. The non-transitory computer readable storage medium of claim 10, wherein the one or more programs comprise instructions to, when executed by the electronic device, cause the electronic device to:
based on determining that the external object is included in the risk region, using the video, generate an image including a visual object corresponding to the external object, another visual object representing the risk region, and a visual representation highlighting the visual object, and
transmit, via the communication interface to a display included in the vehicle, a signal causing the display to output the image.

12. The non-transitory computer readable storage medium of claim 10, wherein the one or more programs comprise instructions to, when executed by the electronic device, cause the electronic device to:
based on determining that the external object is included in the risk region, transmit, via the communication interface to a speaker, a signal causing the speaker to output an audio indicating that the external object is included in the risk region.

13. The non-transitory computer readable storage medium of claim 10, wherein the one or more programs comprise instructions to, when executed by the electronic device, cause the electronic device to:
transmit, via the communication interface to an external electronic device, included in the vehicle, for autonomous driving, the notification information.

14. The non-transitory computer readable storage medium of claim 13, wherein the one or more programs comprise instructions to, when executed by the electronic device, cause the electronic device to:
receive, via the communication interface from the external electronic device, a signal to control a moving direction and braking of the vehicle.

15. The non-transitory computer readable storage medium of claim 10, wherein the vehicle includes a tractor capable of towing a trailer,
wherein the one or more programs comprise instructions to, when executed by the electronic device, cause the electronic device to:
using trailer information indicating a length of a trailer connected to the tractor, determine the risk region with respect to the tractor and the trailer.

16. The non-transitory computer readable storage medium of claim 10, wherein the one or more programs comprise instructions to, when executed by the electronic device, cause the electronic device to:
further using a distance between the vehicle and the external object obtained by performing a back-projection with respect to a visual object, included in the video, corresponding to the external object, determine whether the external object is included in the risk region.

17. The non-transitory computer readable storage medium of claim 10, wherein the one or more programs comprise instructions to, when executed by the electronic device, cause the electronic device to:
using the video and a pretrained model, identify a type of a visual object corresponding to the external object included in the peripheral environment, and
using the type, determine whether the external object is allowed to be included in the risk region.

18. The non-transitory computer readable storage medium of claim 10, wherein the one or more programs comprise instructions to, when executed by the electronic device, cause the electronic device to:
based on identifying the risk region including a blind spot of the camera, using an ultrasonic sensor arranged toward the blind spot, detect another external object positioned in the risk region.

19. A method executed in an electronic device, including a communication interface, in a vehicle, the method comprising:
receiving, via the communication interface, from a camera included in the vehicle, a video with respect to a peripheral environment of the vehicle,
by using the video, obtaining position information with respect to an external object included in the peripheral environment,
receiving, via the communication interface, from a wheel sensor included in the vehicle, rotation information indicating an angle of a steering wheel in the vehicle,
by using the rotation information and the position information, determining whether the external object is included in a risk region expected to be occupied by the vehicle moving in accordance with the angle, and
based on determining that the external object is included in the risk region, generating notification information with respect to the external object.

20. The method of claim 19, the method further comprising:
based on determining that the external object is included in the risk region, by using the video, generating an image including a visual object corresponding to the external object, another visual object representing the risk region, and a visual representation highlighting the visual object, and
transmitting, via the communication interface to a display included in the vehicle, a signal causing the display to output the image.
